(19) United States
(12) Patent Application Publication
(10) Pub. No.: US 2009/0128529 A1
(43) Pub. Date: May 21, 2009

(54) Display Device and Electronic Device

(76) Inventors: Yoshihiro Izumi, Nara (JP); Kazuhiro Uehara, Nara (JP)

Correspondence Address: NIXON & VANDERHYE, PC, 901 NORTH GLEBE ROAD, 11TH FLOOR, ARLINGTON, VA, 22203, US

(21) Appl. No.: 11/887,397

(22) PCT Filed: Mar. 29, 2006
(86) PCT No.: PCT/JP2006/306551

§ 371 Date: Sep. 28, 2007

(30) Foreign Application Priority Data
Mar. 29, 2005 (JP) 2005-093666

(51) Int. Cl. G09G 5/00

(52) U.S. Cl. 345/207

(57) ABSTRACT

A display apparatus including an optical sensor in its peripheral region is intended to response to visible rays efficiently by preventing a malfunction due to the reaction of the optical sensor to near ultraviolet rays. For this purpose, a display apparatus that includes an active matrix substrate (2) having a pixel array region (8) in which a plurality of pixels are arranged on a base substrate (14) is configured as follows: an optical sensor (11) is provided in a peripheral region (9) located around the pixel array region (8); a color filter (22) for display is provided on the opposite side of TFTs (6) from the base substrate (14); and a color filter (23) for an optical sensor is provided on the opposite side of the optical sensor (11) from the base substrate (14).

### TECHNICAL FIELD

The present invention relates to a display apparatus such as a liquid crystal display apparatus or an electronic luminescent (EL) display apparatus. The present invention also relates to an electronic device including the display apparatus.

### BACKGROUND ART

A flat panel type display apparatus, as typified by a liquid crystal display apparatus, has the characteristics of thinness, light weight, and low power consumption. Moreover, technical development is proceeding to improve the display performance such as coloring, high definition, and support for moving images. Therefore, the flat panel type display apparatus has currently been incorporated into electronic devices, e.g., a wide variety of information devices, TV devices, and amusement devices, such as a mobile telephone, personal digital assistants (PDA), a DVD player, a mobile game device, a notebook PC, a PC monitor, and a TV.

In such a background, a technology for providing a display apparatus with an environment sensor that detects the ambient environment has started to be used. Typical examples of the environment sensor include an optical sensor for detecting the lightness of the ambient environment. In recent years, to achieve better visibility and lower power consumption of a display apparatus, a display system with an auto dimming function has been proposed that controls the brightness of the display apparatus automatically in accordance with the lightness of the operating environment.

The display system having an optical sensor is disclosed, e.g., in JP 4(1992)-174819 A and JP 5(1993)-241512 A. JP 4(1992)-174819 A and JP 5(1993)-241512 A disclose a method for automatically controlling the brightness of a display apparatus based on the illuminance of the operating environment detected by an optical sensor that is provided as a discrete component in the vicinity of the display apparatus. Consequently, brightness control (dimming) can be performed automatically in accordance with the lightness of the ambient environment so that the display brightness is increased in a light environment such as daytime or outdoor conditions and is decreased in a relatively dark environment such as nighttime or indoor conditions. In this case, a viewer of the display apparatus does not feel the glare of the screen in a dark environment, and the visibility can be improved. Moreover, compared to the way in which a display apparatus is used by keeping the display brightness high at all times regardless of the lightness/darkness of the operating environment, the above method can reduce the power consumption and increase the life of the display apparatus. Since the brightness control (dimming) is performed automatically based on the detection information of the optical sensor, a user is not bothered.

As described above, the display apparatus having an auto-dimming function can ensure both good visibility and low power consumption with respect to a change in lightness of the operating environment. Therefore, the display apparatus is particularly useful for mobile devices (a mobile telephone, PDA, a mobile game device, etc.) that are likely to be used outdoors and have to be battery-operated.

As an example of a configuration of a display apparatus incorporating the environment sensor, JP 2002-62856 A discloses a display apparatus that incorporates an optical sensor as a discrete component. FIG. 9 is a schematic configuration diagram showing a liquid crystal display apparatus in JP 2002-62856 A, except for its housing. FIG. 10 is a cross-sectional view showing a portion of the liquid crystal display apparatus in which the optical sensor is mounted.

In this liquid crystal display apparatus, active elements such as thin film transistors (TFTs) are formed on a substrate (active matrix substrate) 901, and the substrate 901 and a counter substrate 902 are bonded together, while a liquid crystal layer 903 is interposed in a region surrounded by a frame-shaped sealing member 925 in a gap between the two substrates. As shown in FIG. 10, the liquid crystal display apparatus is divided roughly into a display region H and a peripheral region (frame region) S.

Optical sensors 907 are provided as discrete components on the periphery of the active matrix substrate 901, i.e., in the peripheral region (frame region) S where the counter substrate is not present. Moreover, a backlight system 914 is provided on the opposite side of the active matrix substrate 901 from the counter substrate 902. A housing 915 is provided so as to cover the opposite side of the backlight system 914 from the active matrix substrate 901 and the circumference of the peripheral region S. The housing 915 has openings 916, each of which is formed at the position facing the optical sensor 907, and light enters the optical sensors 907 through the openings 916.

This configuration in which the optical sensors 907 are provided in the peripheral region S has the following features. When the display mode of a liquid crystal display apparatus is a transmission or semi-transmission type, the backlight system 914 should be provided on the back side of the active matrix substrate 901. However, since the optical sensors 907 are provided in the peripheral region S, light emitted from the backlight system 914 does not reach the optical sensors 907 directly. Thus, it is possible to minimize a malfunction of the optical sensors 907 caused by the light emitted from the backlight system 914. In a normal liquid crystal display apparatus, a polarizing plate (not shown) is attached to the front side of the counter substrate 902. However, since the optical sensors 907 are provided in the peripheral region S, ambient light entering the optical sensors 907 is not blocked by the polarizing plate on the counter substrate 902. Thus, it is possible to introduce a sufficient amount of ambient light into the optical sensors 907. Consequently, the optical sensors 907 can achieve a high S/N.

On the other hand, due to the rapid progress of a manufacturing technique of a display apparatus in recent years, a technology is being established that allows IC chips or various circuit elements, which are conventionally mounted in the peripheral portion of a display apparatus as discrete components, to be formed monolithically in a display apparatus (specifically on a glass substrate constituting the display apparatus) by the same process during the formation of component circuits and elements of the display apparatus.

For example, JP 2002-175026 A discloses an example in which a vertical driving circuit, a horizontal driving circuit, a voltage conversion circuit, a timing generation circuit, an optical sensor circuit, and the like are formed monolithically on the periphery of a display region by the same process when the display region is formed on a substrate. The monolithic formation of such discrete components in the display apparatus can reduce component count or component mounting process, and thus can reduce the size and cost of an electronic device incorporating the display apparatus. Needless to say, the above optical sensor used for brightness control (dimming) of a display apparatus or a dedicated circuit (light amount detector) for the optical sensor also can be formed monolithically in a display apparatus. JP 2002-62856 A discloses a technology for forming a peripheral circuit and an optical sensor monolithically on the substrate by the same process, in place of the optical sensors as discrete components.

General active elements used in an active matrix type display apparatus are thin film transistors (TFTs) using an amorphous Si film or polycrystalline Si film. As described above, when the active elements and various circuit elements are formed monolithically on the same substrate, TFTs using a polycrystalline Si film are mainly used.

Referring to FIG. 11, a structure of a TFT that includes a polycrystalline Si film as a semiconductor layer and is formed on each pixel in a pixel array region (display region) will be described. This TFT structure is called a “top gate structure” or “forward stagger structure”, in which a gate electrode is disposed above a portion of the semiconductor film (polycrystalline Si film) that is to be a channel.

A TFT 500 includes a semiconductor film (polycrystalline Si film) 511 formed on a glass substrate 510, a gate insulation film 512 formed so as to cover the semiconductor film 511, a gate electrode 513 formed on the gate insulation film 512, and a first interlayer insulation film 514 formed so as to cover the gate electrode 513 and the gate insulation film 512. A source electrode 517 is formed on the first interlayer insulation film 514 and connected electrically to a source region 511c of the semiconductor film 511 via a contact hole passing through the first interlayer insulation film 514 and the gate insulation film 512. Similarly, a drain electrode 515 is formed on the first interlayer insulation film 514 and connected electrically to a drain region 511b of the semiconductor film 511 via a contact hole passing through the first interlayer insulation film 514 and the gate insulation film 512. Moreover, a second interlayer insulation film 518 is formed so as to cover them.

In this structure, a region of the semiconductor film 511 facing the gate electrode 513 functions as a channel region 511a. The regions of the semiconductor film 511 other than the channel region 511a are doped with high-concentration impurities, and function as the source region 511c and the drain region 511b.

Although not shown in the drawing, a lightly doped drain (LDD) region doped with low-concentration impurities is formed on both the channel region side of the source region 11c and the channel region side of the drain region 511b to prevent degradation of the electric characteristics caused by hot carriers.

In addition, a pixel electrode 519 for supplying an electric signal to a display medium to be driven is formed on the second interlayer insulation film 518. The pixel electrode 519 is connected electrically to the drain electrode 515 via a contact hole provided in the second interlayer insulation film 518. In many cases, the pixel electrode 519 is generally required to be flat, so that the second interlayer insulation film 518 lying below the pixel electrode 519 needs to function as a flattening film. Therefore, it is preferable to use an organic film (thickness: 2 to 3 μm) made of acrylic resin or the like as the second interlayer insulation film 518. Moreover, the second interlayer insulation film 518 should have patterning performance to form a contact hole in the TFT 500 or take out an electrode in the peripheral region. Thus, an organic film with photosensitivity is likely to be used in general.

On the other hand, if a display apparatus includes TFTs having the above structure in the display region, and an optical sensor for detecting the brightness of ambient light is formed monolithically in the peripheral region with an attempt to minimize an increase in the manufacturing process, the device structure of the optical sensor will have to be limited.

FIG. 12 is a schematic cross-sectional view showing the device structure of an optical sensor 400 that meets such requirements. A semiconductor film 411 constituting the optical sensor is formed on a glass substrate 410, and a doped region (p-region 411c or n-region 411b) of the semiconductor film 411 is formed in a lateral direction (plane direction) rather than a vertical direction (stack direction) with respect to a non-doped region (i-region 411a). In general, a structure having a PIN junction in the lateral direction (plane direction) parallel to the surface on which the semiconductor film 411 is formed is called a PIN type photodiode with a lateral structure.

Each of the members constituting the optical sensor 400 is formed by the same process as those constituting the TFT 500 in FIG. 11. For example, an insulation film 412 is formed on the semiconductor film 411 by using the same material and the same process as the gate insulation film 512. Moreover, a p-side electrode 417 formed by using the same material and the same process as the source electrode 517 and an n-side electrode 415 formed by using the same material and the same process as the drain electrode 515 are formed on a first interlayer insulation film 414.

On the top of them, a surface protective film 418 is formed by using the same material and the same process as the second interlayer insulation film 518. In this case, the second interlayer insulation film 518 in the pixel array region (display region) serves not only to electrically insulate the TFT 500 from the pixel electrode 519, but also to improve the flatness of the surface on which the pixel electrode 519 is formed. Moreover, the second interlayer insulation film 518 in the peripheral region (frame region) outside the pixel array region (display region) serves as the surface protective film 418 of the active matrix substrate to protect the optical sensor 400 and the electrodes connected to the optical sensor 400 from the outside air. Thus, it is desirable that the surface protective film 418 and the second interlayer insulation film 518 are formed by the same process over substantially the entire surface from the display region to the peripheral region.

The optical sensor 400 in FIG. 12 can be used instead of the optical sensor (i.e., a discrete component provided in the peripheral region) of a conventional display apparatus as shown in FIG. 9, and also contributes to reduced component count or component mounting process when the display apparatus in FIG. 9 is incorporated into an electronic device.

JP 6(1994)-188400 A discloses, as another example of a structure of the optical sensor 400, a photodiode having a metal-insulator-semiconductor (MIS) type junction that can be formed monolithically on the same substrate as TFTs that use an amorphous Si film and have a bottom gate structure (reverse stagger structure). Such a MIS type photodiode also can be employed. Moreover, as a configuration of the optical sensor, other device structures also can be used, such as a photoconductor or phototransistor in which two terminals are formed in the lateral direction (plane direction).

### DISCLOSURE OF INVENTION

### Problem to be Solved by the Invention

However, as typified by the optical sensor 400 in FIG. 12, the optical sensor 400 formed by the same process as the TFT 500 of the display region H cannot optimize its performance sufficiently. This is because the semiconductor film 411 of the optical sensor 400 in the peripheral region S has to be formed so that the thickness is extremely small, e.g., 0.05 μm in accordance with the thickness of the semiconductor film (polycrystalline Si film) 511 of the TFT 500 in the display region H.

The optical sensor 400 including such a thin semiconductor film 411 exhibits relatively low sensitivity for red light, but higher sensitivity as the wavelength of light becomes shorter (red green→blue→near ultraviolet rays). This attributes to the following: the wavelength dependence of an absorption coefficient (i.e., the absorption coefficient is small for light on the long-wavelength side) due to the optical band gap of the semiconductor film 411; and lack of the absorption thickness (at the level of a visible light wavelength) of the semiconductor film 411, causing the light on the long-wavelength side to be transmitted easily without being absorbed. Therefore, when a display apparatus is used outdoors, the optical sensor 400 has high sensitivity for near ultraviolet rays of the solar spectrum.

However, one of the purposes of providing a display apparatus with the optical sensor 400 is to make the display apparatus adaptable to significant illuminance changes in the operating environment, thereby achieving good visibility. In the case as described above, the optical sensor 400 detects a change in illuminance of the near ultraviolet rays with high sensitivity. Thus, it is not possible for the optical sensor 400 to precisely detect a change in illuminance of visible rays (particularly green light indicating a peak of the luminosity factor) that affects the visibility. For example, under an environment in which the illuminance is relatively higher in the near ultraviolet region than in the visible light region, even if the glare of light is not sensed by the human eyes, the optical sensor detects a higher illuminance of the near ultraviolet region and may perform brightness control of the display apparatus excessively.

Therefore, with the foregoing in mind, it is an object of the present invention to provide a display apparatus that includes an optical sensor for detecting the brightness of ambient light and can precisely detect a change in illuminance in the visible light region.

### Means for Solving Problem

To achieve the above object, a display apparatus of the present invention includes an active matrix substrate having a pixel array region in which a plurality of pixels are arranged on a base substrate. In the display apparatus, a plurality of active elements for driving a display medium are arranged in the pixel array region. An optical sensor is provided in a peripheral region located around the pixel array region of the active matrix substrate. A color filter for display is provided on the opposite side of the active elements from the base substrate. A color filter for an optical sensor is provided on the opposite side of the color sensor from the base substrate.

Moreover, a display apparatus of the present invention includes an active matrix substrate for driving a display medium, a display region, and a peripheral region other than the display region. In the display region, a plurality of active elements for driving the display medium are arranged on the active matrix substrate, and a color filter for display is provided closer to a viewer than a layer in which the active elements are formed. In the peripheral region, an optical sensor is provided on the active matrix substrate, and a color filter for an optical sensor is provided closer to the viewer than a layer in which the optical sensor is formed. The color filters for display and the color filter for an optical sensor are formed of the same material.

An electronic device of the present invention includes the display apparatus of the present invention.

### EFFECTS OF THE INVENTION

In the display apparatus of the present invention, since a color filter for an optical sensor is provided on the optical sensor located in the display apparatus, the optical sensor is unaffected by ultraviolet rays or near infrared rays, and thus a change in illuminance of visible rays that affects the visibility can be detected precisely.

### BRIEF DESCRIPTION OF DRAWINGS

FIG. 1A is an entire configuration diagram schematically showing a display apparatus of Embodiment 1.

FIG. 1B is a partially cross-sectional view schematically showing the cross-sectional configuration of a pixel portion in a display region and the cross-sectional configuration of an optical sensor portion in the display apparatus of Embodiment 1.

FIG. 2A is an entire configuration diagram schematically showing a display apparatus of Embodiment 2.

FIG. 2B is a partially cross-sectional view schematically showing the cross-sectional configuration of a pixel portion in a display region and the cross-sectional configuration of an optical sensor portion in the display apparatus of Embodiment 2.

FIG. 3 is an entire configuration diagram schematically showing a display apparatus of Embodiment 3.

FIG. 4 is a block diagram showing the schematic configuration of a display apparatus that is a modified example of the display apparatus of Embodiment 3 and has the function of correcting a color balance of a backlight system based on detected values of a plurality of optical sensors.

FIG. 5 is an entire configuration diagram schematically showing a display apparatus of Embodiment 4.

FIG. 6 is a cross-sectional view schematically showing the state of the display apparatus of Embodiment 1 that is enclosed in a housing.

FIG. 7 is a graph showing the spectral response characteristics of a PIN type photodiode.

FIG. 8 is a block diagram showing the schematic configuration of en electronic device of an embodiment of the present invention.

FIG. 9 is an entire configuration diagram of a conventional liquid crystal display apparatus.

FIG. 10 is a schematic cross-sectional view showing a portion of the conventional liquid crystal display apparatus in which an optical sensor is mounted.

FIG. 11 is a schematic cross-sectional view showing a conventional TFT formed in a pixel array region of an active matrix substrate.

FIG. 12 is a schematic cross-sectional view showing a conventional optical sensor formed in a peripheral region of an active matrix substrate.

### DESCRIPTION OF THE INVENTION

### Embodiment 1

Hereinafter, a brief explanation of a display apparatus of Embodiment 1 of the present invention will be given by taking a liquid crystal display apparatus as an example with reference to the drawings.

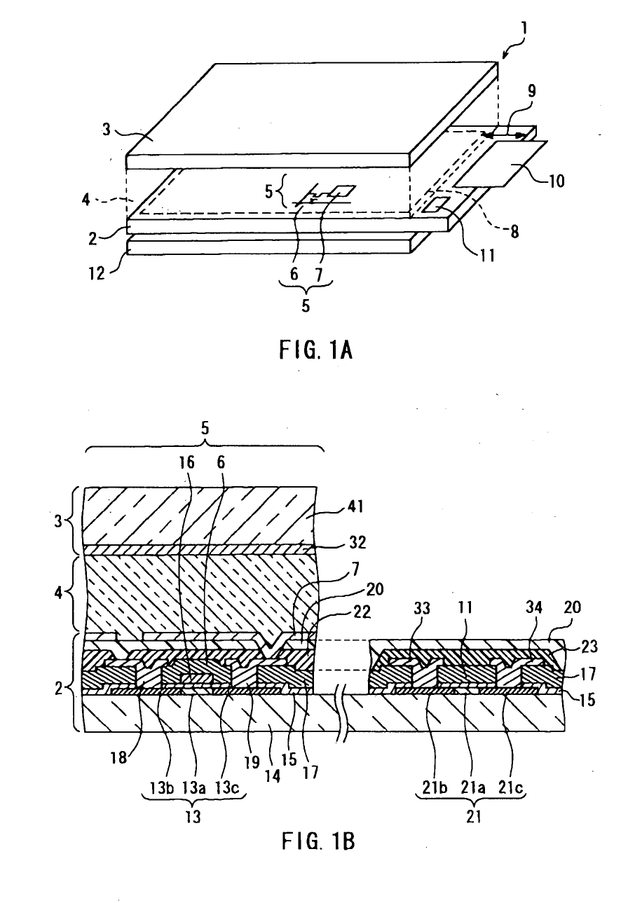

FIG. 1A is an entire configuration diagram of a display apparatus 1 of the present invention. The display apparatus 1 includes an active matrix substrate 2 on which a large number of pixels 5 are arranged in a matrix and a counter substrate 3 located opposite to the active matrix substrate 2. Moreover, the display apparatus 1 includes a display region (pixel array region) 8 in which the pixels 5 are arranged and a peripheral region 9 located close to the display region 8. The counter substrate 3 is provided so as to cover the display region 8 and to expose at least a part of the peripheral region 9 of the active matrix substrate 2.

The active matrix substrate 2 and the counter substrate 3 are bonded together with a frame-shaped sealing member (not shown) provided along the outer edge of the counter substrate 3. A display medium (liquid crystal) 4 is interposed in a gap between the active matrix substrate 2 and the counter substrate 3.

Each of the pixels 5 of the active matrix substrate 2 includes a thin film transistor (TFT) 6 and a pixel electrode 7 for driving the display medium 4. A counter electrode 32, which will be described later, is formed in the counter substrate 3 so as to cover at least the display region 8.

A flexible printed circuit (FPC) 10 for connecting an external driving circuit (not shown) to the display apparatus 1 is mounted on the peripheral region 9 of the active matrix substrate 2. Moreover, an optical sensor 11 for detecting the brightness of ambient light is provided in the peripheral region 9. In addition, peripheral circuits (although not shown, e.g., a driving circuit for driving the TFTs 6 in the display region 8 based on an input signal from the external driving circuit, wiring connected to the optical sensor 11 or the driving circuit, and lead wiring from the display region 8) also are provided appropriately in the peripheral region 9.

The TFTs 6 in the display region 8 and the optical sensor 11 in the peripheral region 9 are formed monolithically on the same substrate by substantially the same process. That is, some constituent members of the optical sensor 11 are formed simultaneously with some constituent members of the TFTs 6.

The display mode of the display apparatus 1 is a transmission mode that utilizes transmitted light. Therefore, a backlight system 12 is provided on the opposite side (back side) of the active matrix substrate 2 from the counter substrate 3. When the display mode is a reflection mode utilizing the reflection of ambient light, or when a self-light emitting element such as EL is used as a display medium, the backlight system 12 is not necessary.

Since the optical sensor 11 is intended to detect ambient light, if light of the backlight system 12 enters the optical sensor 11, it can cause the optical sensor 11 to malfunction. Therefore, care should be taken not to place the backlight system 12 on the lower side of a portion of the active matrix substrate 2 on which the optical sensor 11 is located (i.e., the opposite side of the active matrix substrate 2 from the optical sensor 11), or to prevent the light of the backlight system 12 from entering the optical sensor 11 by providing a light shielding member (aluminum tape etc.) on the back side of a portion of the active matrix substrate 2 on which the optical sensor 11 is located.

The display apparatus 1 can be applied to a display system with an auto-dimming function that automatically controls the display brightness in accordance with the illuminance of ambient light detected by the optical sensor 11. That is, a control circuit can be provided to control the brightness of the backlight system 12 or a luminance signal of a display signal based on the brightness information of ambient light output from the optical sensor 11 in the peripheral region 9 of the active matrix substrate 2, thereby automatically controlling the display brightness of the display apparatus 1.

This control circuit may be formed either integrally with or separately from the display apparatus 1. Examples of forming the control circuit integrally with the display apparatus 1 include the case where the control circuit is formed monolithically in the active matrix substrate 2, and the case where the control circuit is formed independently of the active matrix substrate 2 and then is mounted on the active matrix substrate 2 by a chip on glass (COG) technique or the like. Examples of forming the control circuit separately from the display apparatus 1 include the case where the control circuit is formed independently of the active matrix substrate 2 and then is connected to the active matrix substrate 2 via a FPC or the like, and the case where the control circuit is located in an electronic device including the display apparatus 1, and a signal is transmitted from the control circuit to the active matrix substrate 2.

Using the control circuit the brightness control (dimming) is performed automatically so that the display brightness is increased in a light environment such as outdoor conditions and is decreased in a relatively dark environment such as nighttime or indoor conditions. This can reduce the power consumption and increase the life of the display apparatus.

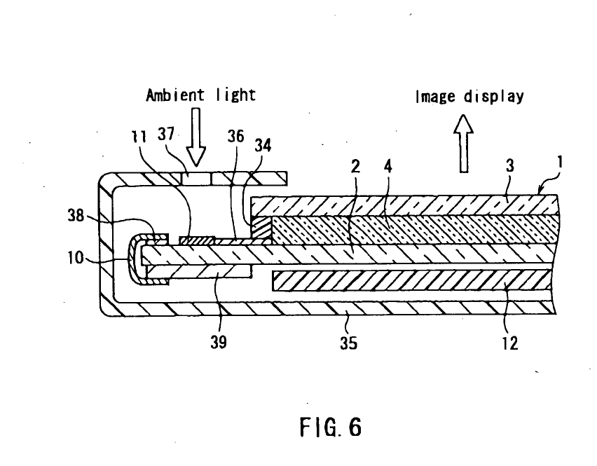

FIG. 6 is a cross-sectional view showing the state of the display apparatus 1 enclosed in a housing 35. An opening 37 of the housing 35 is formed so as to face the position of the optical sensor 11, and ambient light reaches the optical sensor 11 through the opening 37. In FIG. 6, reference numeral 39 denotes a circuit board.

In addition to the optical sensor 11, peripheral circuits (e.g., a driving circuit (not shown) for driving the TFTs 6 in the display region 8 based on an input signal from the circuit board 39, wiring (not shown) connected to the optical sensor 11 or the driving circuit, and lead wiring 36 from the display region 8) also are provided in the peripheral region 9 of the display apparatus 1.

Next, a detailed configuration of the display apparatus 1 of this embodiment will be described with reference to FIG. 1B.

FIG. 1B is a partially cross-sectional view schematically showing the cross-sectional configuration of a pixel (5) portion in the display region 8 and the cross-sectional configuration of an optical sensor (ii) portion in the peripheral region 9 in the display apparatus 1 of FIG. 1A. The cross-sectional configurations of the pixel (5) portion and the optical sensor (11) portion appear on the left and right sides of the sheet of the drawing, respectively. In FIG. 1B, a part of the pixel (5) portion and a part of the optical sensor (11) portion are connected by a broken line, which means that they are positioned at the same height from the surface of a substrate 14.

Referring to FIG. 1B, the configurations of a TFT 6 using a polycrystalline Si film and a pixel 5 including the TFT 6 in this embodiment will be described. The display medium liquid crystal) 4 is interposed in a gap between the active matrix substrate 2 and the counter substrate 3. The thin film transistor (TFT) 6 and the pixel electrode 7 for driving the display medium 4 are formed in the active matrix substrate 2. The common electrode 32 is formed on substantially the entire surface of a transparent substrate 41 of the counter substrate 3.

The configuration of the TFT 6 used in this embodiment is called a “top gate structure” or “foe-ward stagger structure”, in which a gate electrode 16 is disposed above a portion of a semiconductor film (polycrystalline Si film) 13 that is to be a channel. In the present specification, when a plurality of layers are formed on the substrate as described above, the substrate side is identified as a lower side, and the direction in which the distance from the substrate to each layer is increased is identified as an upper side.

The substrate 14 that serves as a base substrate is mainly a glass substrate. For example, non-alkali barium borosilicate glass or aluminoborosilicate glass can be used. The TFT 6 includes the semiconductor film 13 formed on the substrate 14, a gate insulation film 15 (e.g., a silicon oxide film or silicon nitride film) formed so as to cover the semiconductor film 13, the gate electrode 16 (e.g., Al, Mo, Ti, or an alloy thereof) formed on the gate insulation film 15, and a first interlayer insulation film 17 (e.g., a silicon oxide film or silicon nitride film) formed so as to cover the gate electrode 16.

A region of the semiconductor film facing the gate electrode 16 via the gate insulation film 15 functions as a channel region 13a. The regions of the semiconductor film other than the channel region are n+ layers doped with high-concentration impurities, and function as a source region 13b and a drain region 13c. Although not shown in the drawing, a lightly doped drain (LDD) region doped with low-concentration impurities is formed on both the channel region side of the source region 13b and the channel region side of the drain region 13c to prevent degradation of the electric characteristics caused by hot carriers.

Moreover, a base coat film (e.g., a silicon oxide film or silicon nitride film) may be formed on the surface of the substrate 14 (under the semiconductor film 13). The polycrystalline Si film used as the semiconductor film 13 can be obtained by crystallizing a semiconductor film (amorphous Si film) having an amorphous structure with heat treatment such as laser annealing or rapid thermal annealing (RTA).

A source electrode 18 (e.g., Al, Mo, Ti, or an alloy thereof) is formed on the first interlayer insulation film 17 and connected electrically to the source region 13b of the semiconductor film via a contact hole passing through the first interlayer insulation film 17 and the gate insulation film 15. Similarly, a drain electrode 19 (e.g., Al, Mo, Ti, or an alloy thereof) is formed on the first interlayer insulation film 17 and connected electrically to the drain region 13c of the semiconductor film via a contact hole passing through the first interlayer insulation film 17 and the gate insulation film 15.

The above is an explanation of the basic configuration of the TFT 6 used in this embodiment. In the display region 8, a color filter 22 for display and a second interlayer insulation film 20 are formed successively so as to cover the TFT 6. The color filter 22 may have any color of blue, green, red, cyan, magenta, yellow, or the like. The color filters with different colors are provided for each pixel. In many cases, color filters with three primary colors of blue, green, and red are generally used. The second interlayer insulation film 20 is required to play a role in flattening the unevenness of the lower layer as well as providing insulation between the layers. Therefore, an organic film is mainly used because it can be formed by coating or printing.

Moreover, the pixel electrode 7 (e.g., indium-tin-oxide (ITO), indium-zinc-oxide (IZO), or Al) is formed on the second interlayer insulation film 20. The pixel electrode 7 is connected electrically to the drain electrode 19 via a contact hole provided in the second interlayer insulation film 20. It is preferable to use an organic insulation film with photosensitivity as the second interlayer insulation film 20. Thus, the contact hole can be formed easily in the second interlayer insulation film 20 by exposure to light through a mask and development. The organic insulation film with photosensitivity may be, e.g., acrylic, polyimide, or benzo-cyclo-butene (BCB).

Next, the configuration of the optical sensor 11 will be described with reference to FIG. 1B. The configuration of the optical sensor 11 used in this embodiment is called a “photodiode with a lateral structure” that includes a diode in which the PIN junction of a semiconductor is formed in the plane direction (lateral direction) of a substrate.

A PIN diode of a semiconductor film (polycrystalline Si film) 21 is formed on the substrate 14 (i.e., the common substrate on which the TFTs are formed) that serves as a base substrate. The polycrystalline Si film 21 of the optical sensor 11 is formed at the same time and by the same process as the polycrystalline Si film 13 of the TFT 6 in the display region 8. Therefore, the polycrystalline Si film 21 and the polycrystalline Si film 13 have the same thickness. The PIN junction includes a p⁻ layer (region 21b) and an n⁺ layer (region 21c) that are doped with high-concentration impurities, and an i layer (region 21a) that is not doped with impurities. A p⁻ layer or an n⁻ layer doped with low-concentration impurities also can be used alone or in combination instead of the layer.

Moreover, the gate insulation film 15 (e.g. a silicon oxide film or silicon nitride film) and the first interlayer insulation film 17 (e.g., a silicon oxide film or silicon nitride film), which are common to the constituent members in the display region 8, are formed so as to cover the semiconductor film 21 having the PIN junction. In this case, the gate insulation film 15 and the first interlayer insulation film 17 of the TFTs 6 in the pixel array region 8 extend to the peripheral region 9, and thus result in the gate insulation film 15 and the first interlayer insulation film 17 of optical sensor 11.

A p-side electrode 33 (e.g., Al, Mo, Ti, or an alloy thereof) is formed on the first interlayer insulation film 17 and connected electrically to the p, region 21b of the polycrystalline Si film 21 via a contact hole passing through the first interlayer insulation film 17 and the gate insulation film 15. Similarly, an n-side electrode 34 (e.g., Al, Mo, Ti, or an alloy thereof) is formed on the first interlayer insulation film 17 and connected electrically to the n, region 21c of the polycrystalline Si film 21 via a contact hole passing through the first interlayer insulation film 17 and the gate insulation film 15.

The above is an explanation of the basic configuration of the optical sensor 11. In the peripheral region 9, a color filter 23 for an optical sensor and, if necessary, the second interlayer insulation film 20 are formed successively so as to cover the optical sensor 11. The color filter 23 transmits light in the visible light region such as blue, green, red, cyan, magenta, or yellow and is formed by using the same material and/or the same process as the color filter 22.

As described above, in the display apparatus 1 of Embodiment 1, the constituent members of the optical sensor 11 in the peripheral region 9 are basically the same as those of the TFTs 6 in the display region 8. Therefore, the optical sensor 11 and the TFT 6 can share at least part of their manufacturing processes. Accordingly, the TFTs 6 in the display region 8 and the optical sensor 11 in the peripheral region 9 are formed monolithically in the active matrix substrate 2. Such monolithic formation of the TFTs 6 in the display region 8 and the optical sensor 11 in the peripheral region 9 has the advantage of eliminating the need for any additional process for forming the optical sensor 11. Moreover since the TFTs 6 are thin film elements, the optical sensor 11 also is formed as a thin film element. Thus, compared to the above conventional configuration using the optical sensor chip separately as a discrete element, the TFTs 6 and the optical sensor 11 can have substantially the same height from the surface of the base substrate (i.e., the surface of the substrate 14) of the active matrix substrate 2. For this reason, the color filter 22 for display and the color filter 23 for an optical sensor, which are to be formed after the formation of the TFTs 6 and the optical sensor 11, can be formed easily under the same conditions.

By using the same material and/or the same process, the color filter 22 for display and the color filter 23 for an optical sensor also can be formed monolithically on the active matrix substrate 2. When the color filter 22 for display and the color filter 23 for an optical sensor are formed by using the same material and/or the same process, the color filter 23 can be formed easily on the optical sensor 11 without increasing the number of manhours or members and the cost.

The color filter 22 for display and the color filter 23 for an optical sensor can be formed by applying (or laminating) a resin material, in which a pigment is dispersed in the resin, with a known method (spin coating, transfer, printing, inkjet, etc.).

The structural features of the display apparatus 1 of this embodiment are the following points: the display apparatus 1 includes the display region 8 and the peripheral region 9; the optical sensor 11 for detecting the brightness of ambient light is formed in the peripheral region 9; and the color filter 23 for an optical sensor is formed on the optical sensor 11 in the peripheral region 9. The location or the layer where the color filter 23 is arranged is not limited, as long as it is provided above the layer of the optical sensor 11 (i.e., on the side closer to a viewer).

In the display apparatus 1 of the present invention, the color filter 23 is provided on the optical sensor 11. Therefore, the optical sensor 11 is not affected by the illuminance of near ultraviolet rays or near infrared rays. Thus, the optical sensor 1I can precisely detect a change in illuminance of visible rays that affects the visibility.

When the semiconductor film (polycrystalline Si film) 13 of the TFTs G and the semiconductor film (polycrystalline Si film) 21 of the optical sensor 11 are formed in the same layer, the semiconductor film 21 of the optical sensor 11 has substantially the same thickness as the semiconductor film 13 of the active elements 6, so that the sensitivity of the optical sensor 11 for infrared light becomes relatively low. However, since the color filter 23 is provided on the upper side of the optical sensor 11, the wavelength characteristics can be changed to achieve desired performance.

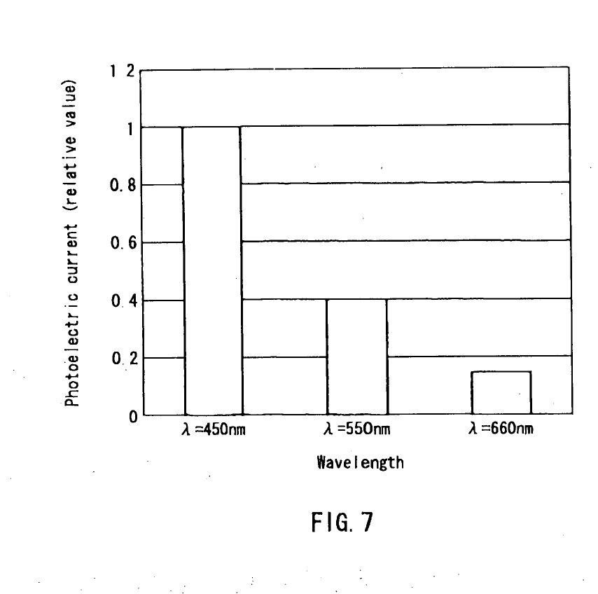

As described above, the optical sensor 11 formed monolithically with the TFTs 6 is likely to transmit light (red light) in the long-wavelength region of the visible light region, and the sensitivity for red light becomes relatively low because the semiconductor film 21 of a light receiving portion is thin. FIG. 7 shows the spectral response characteristics (a relative value of the amount of photoelectric current) of a PIN photodiode using a thin polycrystalline Si film with a thickness of 0.05 nm. As can be seen from FIG. 7, the photodiode tends to improve its sensitivity in the order of red, green, and blue colors of light.

Therefore, when the absolute value of sensitivity of the optical sensor 11 is considered important, it is preferable to use blue or green (particularly blue) rather than red for the color filter 23. In this case, compared to a red color filter 23 for an optical sensor, the optical sensor 11 can be designed to reduce the size, thereby increasing the degree of freedom in the layout of the optical sensor 11 and decreasing the peripheral region (frame region) 9.

When a transparent (white) color filter, along with red, blue, and green color filters, is used as a color filter for display in the display region 8 (e.g., when color filters with four colors of RGBW are used), and this transparent (white) color filter has a transmittance of 50% or less for near ultraviolet rays or near infrared rays, it is also possible to use transparent (white) color for the color filter 23.

On the other hand, when not only the absolute value of sensitivity, but also the sensitivity characteristics corresponding to the human luminosity characteristics are considered important, a green color filter is suitable for the color filter 23.

### Embodiment 2

Embodiment 2 of the present invention describes a modified example of the display apparatus 1 as described in Embodiment 1. For convenience, the same components as those of the display apparatus 1 of Embodiment 1 are denoted by the same reference numerals, and the explanation may not be repeated.

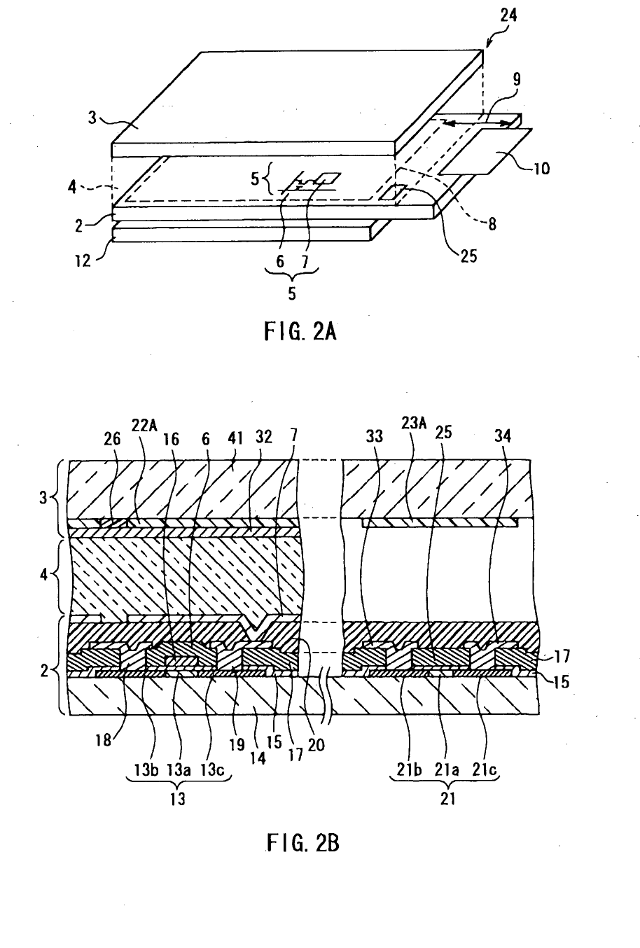

FIG. 2A is an entire configuration diagram of a display apparatus 24 according to Embodiment 2 of the present invention. The display apparatus 24 includes an active matrix substrate 2 on which a large number of pixels 5 are arranged in a matrix and a counter substrate 3 located opposite to the active matrix substrate 2. Moreover, the display apparatus 24 includes a display region 8 in which the pixels 5 are arranged and a peripheral region 9 located close to the display region 8. The counter substrate 3 is provided so as to cover the display region 8 and to expose at least a part of the peripheral region 9 of the active matrix substrate 2.

The active matrix substrate 2 and the counter substrate 3 are bonded together with a frame-shaped sealing member (not shown) provided along the outer edge of the counter substrate 3. A display medium (liquid crystal) 4 is interposed in a gap between the active matrix substrate 2 and the counter substrate 3.

Each of the pixels 5 of the active matrix substrate 2 includes a thin film transistor (TFT) G and a pixel electrode 7 for driving the display medium 4. A color filter 22A for display, a black matrix 26, and a counter electrode 32, which will be described later, are formed in the counter substrate 3 so as to cover at least the display region 8.

A flexible printed circuit (FPC) 10 for connecting an external driving circuit (not shown) to the display apparatus 24 is mounted on the peripheral region 9 of the active matrix substrate 2. Moreover, an optical sensor 25 for detecting the brightness of ambient light is provided in the peripheral region 9. In addition, peripheral circuits (although not shown, e.g., a driving circuit for driving the TFTs 6 in the display region 8 based on an input signal from the external driving circuit, wiring connected to the optical sensor 25 or the driving circuit, and lead wiring from the display region 8) also are provided appropriately in the peripheral region 9.

The TFTs G in the display region 8 and the optical sensor 25 in the peripheral region 9 are formed monolithically on the same substrate by substantially the same process. That is, some constituent members of the optical sensor 25 are formed simultaneously with some constituent members of the TFTs G.

The basic operation and display mechanism of the display apparatus 24 are the same as those of the display apparatus 1 of Embodiment 1, and the display apparatus 24 also can be enclosed in the housing 35, as shown in FIG. 6.

Hereinafter, a configuration of the display apparatus 24 will be described while referring mainly to the features different from the display apparatus 1 of Embodiment 1 with reference to FIG. 2B. Therefore, the explanation of the same feature will be omitted.

FIG. 2B is a partially cross-sectional view schematically showing the cross-sectional configuration of a pixel (5) portion in the display region 8 and the cross-sectional configuration of an optical sensor (25) portion in the peripheral region 9 in the display apparatus 24 of FIG. 2A. The cross sectional configurations of the pixel (5) portion and the optical sensor (25) portion appear on the left and right sides of the sheet of the drawing, respectively. In FIG. 2B, a part of the pixel (5) portion and a part of the optical sensor (25) portion are connected by a broken line, which means that they are positioned at the same height from the surface of a substrate 14.

The display apparatus 24 differs from the display apparatus 1 of Embodiment 1 in the following points: the color filter 22A for display in the display region 8 and a color filter 23A for an optical sensor in the peripheral region 9 are provided on the counter substrate side rather than the active matrix substrate side; and the counter substrate 3 extends to cover the region above the optical sensor 25 in the peripheral region 9.

In the display apparatus 24, the color filter 23A for an optical sensor is provided on the counter substrate 3 at the position above the optical sensor 25, as with the display apparatus 1 of Embodiment 1. Therefore, the optical sensor 25 is not affected by the illuminance of near ultraviolet rays or near infrared rays. Thus, the optical sensor 25 can precisely detect a change in illuminance of visible rays that affects the visibility. Moreover, the color filter 23A located above the optical sensor 25 is formed by using the same material and/or the same process as the color filter 22A for display, and therefore can be formed easily above the optical sensor 25 without increasing the number of manhours or members.

When the semiconductor film 13 of the active element 6 and the semiconductor film 21 of the optical sensor 25 are formed in the same layer, the semiconductor film 21 of the optical sensor 25 has substantially the same thickness as the semiconductor film 13 of the active element 6, so that the sensitivity of the optical sensor 25 for infrared light becomes relatively low. However, since the color filter 23A is provided on the upper side of the optical sensor 25, the wavelength characteristics can be changed to achieve desired performance.

Moreover, when the absolute value of sensitivity of the optical sensor 25 is considered important, it is preferable to use blue or green (particularly blue) rather than red for the color filter 23A. In this case, compared to a red color filter 23A for an optical sensor, the optical sensor 25 can be designed to reduce the size, thereby increasing the degree of freedom in the layout of the optical sensor 25 and decreasing the peripheral region (frame region) 9. On the other hand, when not only the absolute value of sensitivity, but also the sensitivity characteristics corresponding to the human luminosity characteristics are considered important, a green color filter is suitable for the color filter 23A.

### Embodiment 3

Embodiment 3 of the present invention describes a modified example of the display apparatus 1 as described in Embodiment 1. For convenience, the same components as those of the display apparatus 1 of Embodiment 1 are denoted by the same reference numerals, and the explanation may not be repeated.

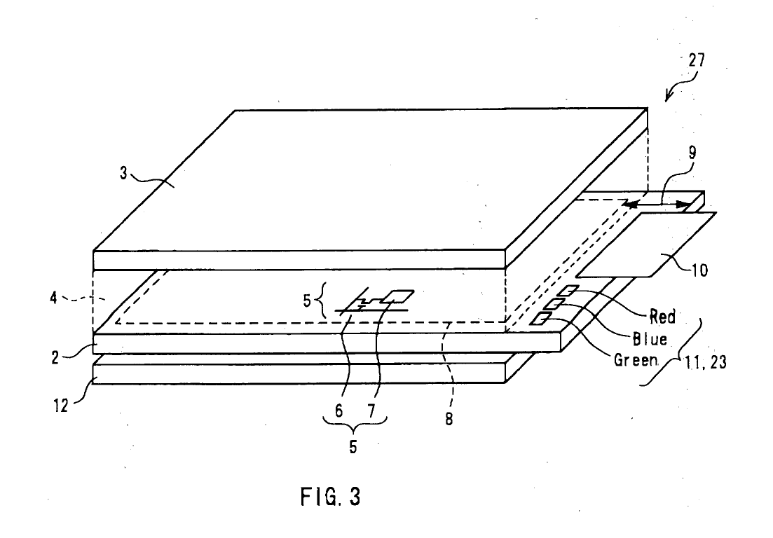

FIG. 3 is an entire configuration diagram of a display apparatus 27 according to Embodiment 3 of the present invention. The display apparatus 27 differs from the display apparatus 1 of Embodiment 1 in that a plurality of optical sensors 11 (three sensors are shown in FIG. 3) are formed in a peripheral region 9 of an active matrix substrate 2. Moreover, color filters 23 with different colors (red, blue, and green in FIG. 3) are formed on the respective optical sensors 11.

With this configuration, the display apparatus 27 can obtain the brightness information (e.g., red light of morning glow or sunset glow) of ambient light for each color (wavelength), and also can detect a color tone (color balance) in addition to the brightness of ambient light. The display apparatus 27 further includes a control circuit (not shown) for controlling the color balance of a backlight system 12 or a color signal of a display signal of the display apparatus 27. The display color balance of the display apparatus 27 is adjusted based on the detected values of the color balance, so that the display apparatus can have superior visibility. In this case, a LED backlight including red, blue, and green LEDs is useful for the backlight system 12 because it can facilitate the control of each color.

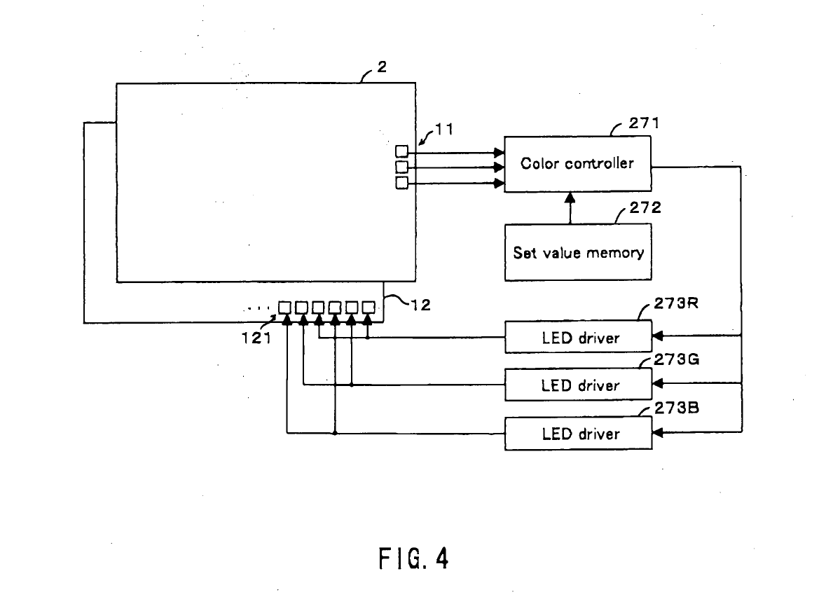

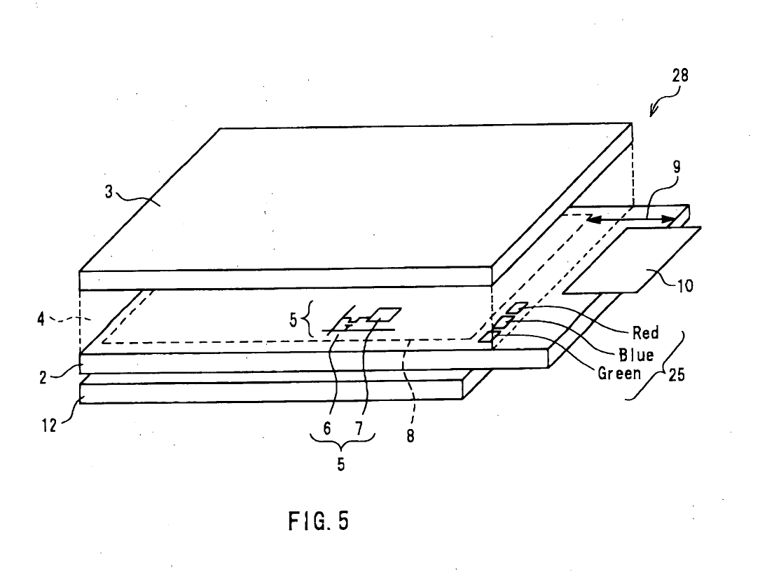

Referring to FIG. 4, a schematic configuration of the display apparatus 27 having the function of correcting the color balance of the backlight system 12 based on the detected values of the optical sensors 11 will be described. In FIG. 4, the configuration includes three optical sensors 11 having red, blue, and green color filters 23 (not shown) for an optical sensor. The three optical sensors 11 detect the wavelength components of red, blue, and green in ambient light and output them, respectively. The backlight system 12 includes red, blue, and green LEDs 121 as light sources. These LEDs 121 are arranged regularly on the side or the under surface of a light guide plate of the backlight system 12.

As shown in FIG. 4, the display apparatus 27 includes a color controller 271, a set value memory 272, and LED drivers 273R, 273G, and 273B for driving the red, green, and blue LEDs 121. The set value memory 272 stores set values of the brightness and the color coordinates beforehand. The color controller 271 receives each of the output signals from the optical sensors 11, compares the output values of the optical sensors 11 with the values stored in the set value memory 272, and outputs the comparison results to the LED drivers 273R, 273G, and 273B. The LED drivers 273R, 273G, and 273B control a driving current for each of the red, green, and blue LEDs 121 in accordance with the comparison results. In FIG. 4, although the LEDs of the backlight system 12 are arranged in the order of R, G, and B, the order of arrangement of the LEDs is not limited thereto.

When the display mode of the display apparatus 27 is a reflection mode (in which display is performed using the reflected light of ambient light) that does not require the backlight system 12, the color tone of display can be affected significantly by the color of ambient light (environmental light). Therefore, a color signal of a display signal is corrected based on the detected values of the optical sensors 11, thus improving the display performance considerably. Moreover, the configuration that includes the color controller 271, the set value memory 272, and the like in FIG. 4 also may be applied to a configuration for correcting the color signal of the display signal.

When a plurality of colors are used for the color filters 23 for an optical sensor, it is preferable to use color filters with three primary colors of red, blue, and green. However, the color filters are not limited thereto, and other colors such as cyan, magenta, yellow, and transparent (white) also can be used with the primary colors. Moreover, all the color filters 23 located on the respective optical sensors 11 are formed by using the same maternal and the same process as the color filter 22 for display, and therefore can be formed easily on the optical sensors 11 without increasing the number of manhours or members.

### Embodiment 4

Embodiment 4 of the present invention describes a modified example of the display apparatus 24 as described in Embodiment 2. For convenience, the same components as those of the display apparatus 24 of Embodiment 2 are denoted by the same reference numerals, and the explanation may not be repeated.

FIG. 5 is an entire configuration diagram of a display apparatus 28 according to Embodiment 4 of the present invention. The display apparatus 28 differs from the display apparatus 24 of Embodiment 2 in that a plurality of optical sensors 25 (three sensors are shown in FIG. 5) are formed in a peripheral region 9 of an active matrix substrate 2. Moreover, color filters 23A with different colors (red, blue, and green in FIG. 5) are formed on a counter substrate 3 at the positions facing the respective optical sensors 25.

With this configuration, the display apparatus 28 can obtain the brightness information (e.g., red light of morning glow or sunset glow) of ambient light for each color (wavelength), and also can detect a color tone (color balance) in addition to the brightness of ambient light.

Like the configuration as shown in FIG. 4, the display apparatus 28 further includes a control circuit for controlling the color balance of a backlight system 12 or a color signal of a display signal of the display apparatus 28. The display color balance of the display apparatus 28 is adjusted based on the detected values of the color balance, so that the display apparatus can have superior visibility. In this case, a LED backlight including red, blue, and green LEDs is useful for the backlight system 12 because it can facilitate the control of each color.

When a plurality of colors are used for the color filters 23A for an optical sensor, it is preferable to use color filters with three primary colors of red, blue, and green. However, the color filters are not limited thereto, and other colors such as cyan, magenta, and yellow also can be used with the primary colors.

The display apparatuses as described in Embodiments 1 to 4 can be widely applied to display apparatuses including active elements and color filters, e.g., to various types of color display apparatuses such as a liquid crystal display apparatus, an EL display apparatus, and an electrophoretic display apparatus.

In the above embodiments, although a polycrystalline Si film is used to form the TFTs and the optical sensor, they also can be formed of an amorphous Si film. Moreover, not only the TFTs having a top gate structure (forward stagger structure), but also the TFTs having a bottom gate structure (reverse stagger structure) may be used. The optical sensor may be a photodiode having a Schottky junction or MIS junction in addition to the PIN junction. For example, reference can be made to JP 6 (1994)-188400 A disclosing a method in which TFTs that use an amorphous Si film and have a bottom gate structure (reverse stagger structure) and a photodiode that has a MIS junction are formed monolithically on the same substrate. Moreover, as a configuration of the optical sensor 11, other device structures also can be used, such as a photoconductor or phototransistor in which two terminals are formed in the lateral direction (plane direction).

In the above explanation, the optical sensors 11, 25 are formed monolithically on the active matrix substrate by substantially the same process as the TFTs 6. However, the optical sensors also may be mounted on the glass substrate of the active matrix substrate by the COG technique.

The display apparatuses as described in Embodiments 1 to 4 may be incorporated into electronic devices, e.g., a wide variety of information devices, TV devices, and amusement devices, such as a mobile telephone, PDA, a DVD player, a mobile game device, a notebook PC, a PC monitor, and a TV. Thus, it is possible to provide an electronic device including the display apparatus with the above advantageous features.

### Embodiment 5

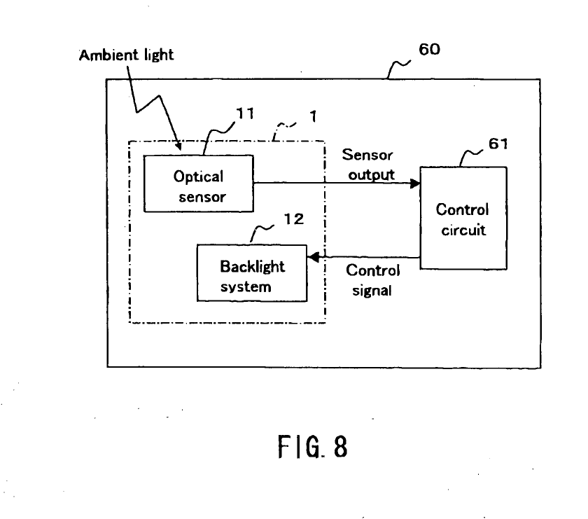

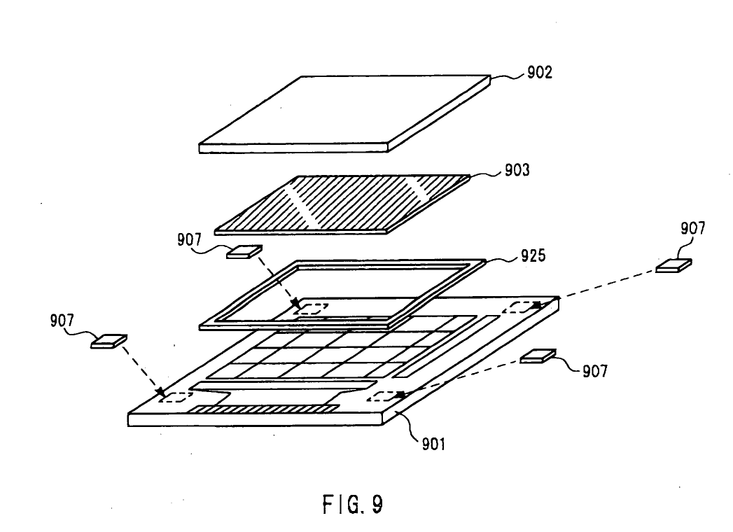

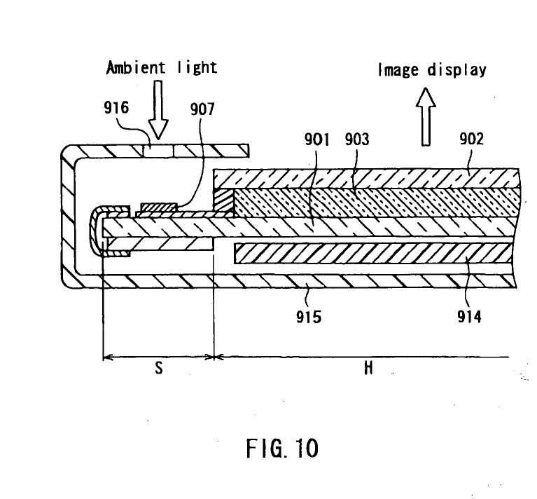

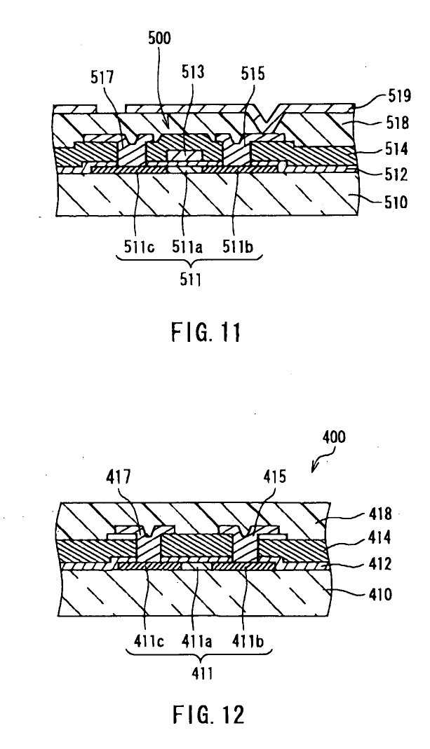

FIG. 8 shows a schematic configuration of an electronic device of an embodiment of the present invention. As shown in FIG. 8, en electronic device 60 of this embodiment includes the display apparatus 1 of Embodiment 1 and a control circuit 61 for controlling the display brightness of the display apparatus 1 in accordance with the brightness information of ambient light detected by the optical sensor 11 of the display apparatus 1. In FIG. 8, the illustration of functional blocks in the display apparatus 1 and the electronic device 60 is simplified. The control circuit 61 may have the function of controlling any operation of the electronic device 60 as well as controlling the display brightness. The electronic device 60 may have any functional block other than that shown in FIG. 8, depending on its intended use or the like.

The control circuit 61 controls the display brightness of the display apparatus 1 by adjusting the brightness of the backlight system 12 in accordance with the brightness information (sensor output) of ambient light detected by the optical sensor 11. The display apparatus 1 is a liquid crystal display apparatus, and therefore the display brightness can be adjusted by controlling the brightness of backlight. However, when a self-light emitting element such as an EL element is used as a display apparatus, the control circuit 61 is configured so as to control the emission brightness of the self-light emitting element.

In this embodiment, the display apparatus 1 of Embodiment 1 has been used. However, an electronic device including the display apparatus according to any of Embodiments 2 to 4 and their modified examples also falls in the range of the present invention.

In particular, when an electronic device uses the display apparatus of Embodiment 3 or 4, the control circuit 61 may control the color balance of the backlight system 12 or a color signal of a display signal of the display apparatus in accordance with the outputs of the optical sensors 11, 25 corresponding to the color filters 23 or 23A with different colors.

As described above, an electronic device that achieves low power consumption and an easily readable display can be provided by controlling the display brightness to be necessary and sufficient brightness in accordance with the lightness of the surroundings. The electronic device of this embodiment can ensure both good visibility and low power consumption with respect to a change in lightness of the operating environment. Therefore, the electronic device is particularly useful for mobile devices that are likely to be used outdoors and have to be battery-operated. Specific examples of the mobile devices include an information terminal such as a mobile telephone or PDA, a mobile game device, a portable music player, a digital camera, and a video camera, although the application of the present invention is not limited to these devices.

In this embodiment, the control circuit 61 for controlling the display brightness of the display apparatus is provided outside the display apparatus However, the control circuit also may be provided as an integral part of the display apparatus.

### INDUSTRIAL APPLICABILITY

The present invention can be widely applied to display apparatuses including an optical sensor, e.g., to various types of display apparatuses such as a liquid crystal display apparatus, an EL display apparatus, and an electrophoretic display apparatus. Consequently, the present invention also can be used for electronic devices (e.g., a mobile telephone, PDA, a DVD player, a mobile game device, a notebook PC, a PC monitor, or a TV) including such a display apparatus.

1. A display apparatus comprising:
an active matrix substrate having a pixel array region in which a plurality of pixels are arranged on a base substrate,
wherein a plurality of active elements for driving a display medium are arranged in the pixel array region,
an optical sensor is provided in a peripheral region located around the pixel array region of the active matrix substrate,
a color filter for display is provided on an opposite side of the active elements from the base substrate, and
a color filter for an optical sensor is provided On an opposite side of the optical sensor from the base substrate.

2. The display apparatus according to claim 1, wherein a semiconductor film of the active elements and a semiconductor film of the optical sensor are formed in a same layer.

3. The display apparatus according to claim 1, wherein the color filter for display and the color filter for an optical sensor are formed of a same material.

4. The display apparatus according to claim 1, wherein the color filter for display and the color filter for an optical sensor are formed by a same process.

5. The display apparatus according to claim 1, wherein the active elements and the optical sensor are formed monolithically on the active matrix substrate.

6. The display apparatus according to claim 1, wherein the color filter for display and the color filter for an optical sensor are formed on the active matrix substrate.

7. The display apparatus according to claim 1, wherein a counter substrate is provided opposite to the active matrix substrate with the display medium interposed therebetween, and
the color filter for display and the color filter for an optical sensor are formed on the counter substrate.

8. The display apparatus according to claim 1, wherein the color filter for an optical sensor is either blue or green.

9. The display apparatus according to claim 1, wherein a control circuit is provided for controlling display brightness based on brightness information of ambient light detected by the optical sensor.

10. The display apparatus according to claim 1, wherein a plurality of optical sensors are provided in the peripheral region, and
color filters for an optical sensor having a plurality of colors are provided for each of the optical sensors.

11. The display apparatus according to claim 10, wherein the color filters for an optical sensor having a plurality of colors comprise color filters with at least three colors of blue, green, and red.

12. The display apparatus according to claim 10, wherein a control circuit is provided for controlling a display color balance based on color information of ambient light detected by the optical sensors.

13. An electronic device comprising the display apparatus according to claim 1.
